(19) United States
(12) Patent Application Publication
(10) Pub. No.: US 2026/0229026 A1
(43) Pub. Date: Aug. 6, 2026

(54) Machine Learning Pipeline Architecture

(71) Applicant: LuxTronic, Inc., Greenwood Village, CO (US)

(72) Inventors: Christopher J. Piekarski, Broomfield, CO (US); Christopher Couture Del Valle, Boston, MA (US)

(21) Appl. No.: 19/045,000

(22) Filed: Feb. 4, 2025

(51) Int. Cl. G06V 10/94; G06F 3/0482; G06F 3/04847; G06F 9/451; G06F 16/242; G06F 40/205; G06V 10/25; G06V 10/70; G06V 10/764; G06V 10/82; G06V 20/70

(52) U.S. Cl. CPC G06V 10/945; G06F 3/0482; G06F 3/04847; G06F 9/451; G06F 16/243; G06F 40/205; G06V 10/25; G06V 10/764; G06V 10/82; G06V 10/87; G06V 20/70

(57) ABSTRACT

This disclosure provides methods, components, devices, and systems for optimizing deployment of project-specific machine learning models using interactive configurations. Some aspects, more specifically, relate to a method that supports an interactive interface for machine learning creation and implementation. A user interface is generated onto a display that includes selection fields associated with a machine learning project. From the selection fields, users can perform selections associated with a specific machine learning project. Once received, the method initiates the machine learning project and trains a machine learning model using annotated training data. Once trained, the machine learning model is integrated into a computing environment of a production system associated with the machine learning project. Additional features include generative pre-trained transformer (GPT) features allowing users to interact with an interface and receive technical specifics associated with the machine learning project.

### BACKGROUND

This disclosure relates generally to a machine learning model pipeline and, more specifically, to optimizing the deployment of project-specific machine learning models using interactive configurations.

A machine learning pipeline is a structured sequence of processes and steps that automate the workflow involved in developing and deploying machine learning models. The pipeline attempts to ensure that each step of the machine-learning process is executed in a consistent, efficient, and reproducible manner.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of development and deployment of project-specific machine learning models using interactive configurations. The method includes generating a user interface (UI) including selection fields associated with a machine learning project onto a display and receiving, via the UI, selections from the selection fields associated with the machine learning project and machine learning model characteristics. The method also includes initializing the machine learning project based, at least partially, on the selections, training a machine learning model associated with the machine learning project using training data. The method further includes integrating the machine learning model into a computing environment of a production system associated with the machine learning project.

In some examples, the method further includes implementing a generative pre-trained transformer (GPT) configured to respond to inquiries associated with the machine learning project and other related projects using database schema of the database, receiving, via the UI, a text string inputted into the input field, parsing the text string into relevant fields associated with a project, generating a query based on the relevant fields and the database schema, retrieving query results of the query inputted into the database, converting the query results into a natural language explanation by inputting the query results into the GPT, and providing the natural language explanation associated with the text string.

In some examples, the method further includes receiving, via the UI, a message including an image and a text string, detecting contents of the message that indicate a process request of the image, classifying the image with a label indicating a project suited for object detection of the image, selecting the machine learning model from a machine learning repository and associated with the project, producing predictions for detected objects in the image using the machine learning model, and providing a processed image including the predictions of the detected objects found in the image.

One innovative aspect of the subject matter described in this disclosure can be implemented into a computing device as a system for development and deployment of project-specific machine learning models using interactive configurations. The system includes one or more memories that store processor-executable code, and one or more processors coupled with the one or more memories and individually or collectively configured to, in association with executing the code, cause the system to generate a user interface (UI) including selection fields associated with a machine learning project onto a display, receive, via the UI, selections from the selection fields associated with the machine learning project and machine learning model characteristics, initialize the machine learning project based, at least partially, on the selections, train a machine learning model associated with the machine learning project using training data, and integrate the machine learning model into a production system associated with the machine learning project.

Another innovative aspect of the subject atter described in this disclosure can be implemented as a non-transitory computer-readable storage medium including instructions stored thereon which, when executed by a processor, cause the processor to generate a user interface (UI) including selection fields associated with a machine learning project onto a display, receive, via the UI, selections from the selection fields associated with the machine learning project and machine learning model characteristics, initialize the machine learning project based, at least partially, on the selections, train a machine learning model associated with the machine learning project using training data, and integrate the machine learning model into a production system associated with the machine learning project.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The systems, methods, and devices of this disclosure each have several innovative aspects, no single one of which is solely responsible for the desirable attributes disclosed herein.

FIG. 1 illustrates a block diagram of an exemplary development and deployment of project-specific machine learning models using interactive configurations, in accordance with embodiments of the present disclosure.

FIG. 2 illustrates a block diagram of an example cloud configuration using aspects of the machine learning pipeline system, in accordance with embodiments of the present disclosure.

FIG. 3 illustrates a flowchart for dynamic creation of a project specific machine learning model based on user input and selections, in accordance with embodiments of the present disclosure.

FIG. 4 illustrates a flowchart for providing natural language explanations for questions related to machine learning projects, in accordance with embodiments of the present disclosure.

FIG. 5 illustrates a flowchart for providing inferences to user-provided images using machine learning models stored in a machine learning repository, in accordance with embodiments of the present disclosure.

FIG. 6 illustrates a schematic diagram of an exemplary environment in which a machine learning pipeline system can operate, in accordance with embodiments of the present disclosure.

FIG. 7 illustrates a block diagram of an exemplary computing device configured to operate a machine learning pipeline system, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates generally to a machine learning model pipeline and, more specifically, to optimizing the development and deployment of project-specific machine learning models using interactive configurations. The following description is directed to some particular examples for the purpose of describing innovative aspects of this disclosure. However, a person having ordinary skill in the art will readily recognize that the teachings herein can be applied in a multitude of different ways.

### Overview

A machine learning pipeline is a structured and automated or semi-automated sequence of processes designed to streamline the development and deployment of machine learning models. The process begins with data collection and ingestion, where raw data is gathered from various sources such as databases, APIs, or data lakes and ingested into a storage system for further processing. Once the data is collected, the next step involves data pre-processing and cleaning, which includes handling missing values, removing duplicates, and correcting errors to ensure the data is accurate and usable. Additionally, data transformation techniques such as normalization and encoding of categorical variables are applied to prepare the data for analysis.

Feature engineering follows, where new features are created, or existing ones are modified to improve model performance. This step can also involve selecting the most relevant features to reduce dimensionality and enhance model efficiency. The prepared data is then split into training, validation, and test sets to evaluate the model's performance accurately.

Model training is the core step where an appropriate machine learning algorithm is selected, and the model is trained using the training dataset. During this process, the model's parameters are adjusted to minimize error. After training, the model is evaluated using the validation dataset to tune hyperparameters and prevent overfitting. Performance metrics such as accuracy, precision, recall, and F1 score are used to measure the model's effectiveness.

Once the model is trained and evaluated, it is deployed to a production environment where it can make predictions on new data. This deployment step includes setting up monitoring systems to track the model's performance and detect any issues. Continuous monitoring ensures the model remains accurate and reliable over time, and retraining may be necessary with new data to maintain performance.

Automation and orchestration play a crucial role in a machine-learning pipeline. Various tools can be used to automate the entire workflow, manage tasks, and ensure reproducibility and scalability. This automation saves time, reduces errors, and allows the process to handle larger datasets and more complex models efficiently. Overall, a machine learning pipeline provides a consistent, efficient, and maintainable approach to developing and deploying machine learning models.

Limitations on machine learning pipelines remain, however, as these pipelines can be complex, as integrating diverse tools and frameworks within a pipeline often leads to compatibility issues, and managing consistent environments across development, testing, and production stages is challenging. Gaps in automation can also result in manual interventions, increasing the risk of errors, while orchestration overhead from managing dependencies and scheduling tasks efficiently adds to the complexity. Users who lack expertise may struggle with understanding and implementing the various steps and components of the pipeline. This can lead to misconfigurations, inefficient workflows, and, ultimately, suboptimal model performance.

For instance, data pre-processing and cleaning can be challenging for users with limited experience. Proper handling of missing values, outliers, and data transformations requires a proper understanding of statistical techniques and domain knowledge. Inadequate pre-processing can result in poor-quality data, which negatively impacts model accuracy and reliability.

The complexity of selecting the appropriate machine-learning algorithms and tuning hyperparameters can also be overwhelming for inexperienced users. Without a solid foundation in machine learning principles, users may choose suboptimal algorithms or fail to properly tune the hyperparameters, resulting in models that do not perform well. Additionally, understanding how to set up and configure environments, manage dependencies, and ensure compatibility between different tools requires technical proficiency. Users who are not well-versed in these areas may encounter frequent errors and difficulties, leading to delays and frustration.

Various aspects of the disclosure improve existing technologies, as well as others, by providing methods, components, and systems that support the optimization of deployment of project-specific machine learning models using interactive configurations. For example, embodiments improve machine learning approaches involving production line automation using computer vision systems to automate quality control processes in manufacturing environments. Using the disclosed machine learning pipeline, users can intuitively create project-specific models through user-specified dataset configurations. Embodiments also allow users to interact with a collection of projects to assist the user in determining the optimal solution for their needs.

More specifically, in some embodiments, the machine learning pipe provides an optimized system for developing object detection models, such as YOLO (You Only Look Once). This pipeline capitalizes on a hybrid architecture that combines cloud resources, making it a flexible, cost-effective solution for initial model development and training, especially suited for users working with limited machine learning development knowledge. The strategic integration of cloud-based storage for data storage and project management allows seamless accessibility and organization of datasets while also providing the computational muscle to perform training, fine-tuning, and evaluation of deep learning models.

In some embodiments, the machine learning pipeline provides an interactive environment for configuring projects and datasets. Users can intuitively set parameters, adjust model configurations, and visualize progress, streamlining the model setup and training process without the need for extensive coding.

Particular aspects of the subject matter described in this disclosure can be implemented to realize one or more of the following potential advantages. The present disclosure aims to provide an interactive environment that can assist users in dataset preparation, model training and evaluation, cloud-based implementation, and real-time collaboration and monitoring features. Embodiments of the disclosure can also be implemented on collaboration platforms, and updates on training progress, performance metrics, and error alerts can be provided. These features enhance the productivity and reliability of deployed machine learning models in projects by allowing users and teams to stay informed and engaged throughout the training and deployment process.

### Example Machine Learning Pipeline System

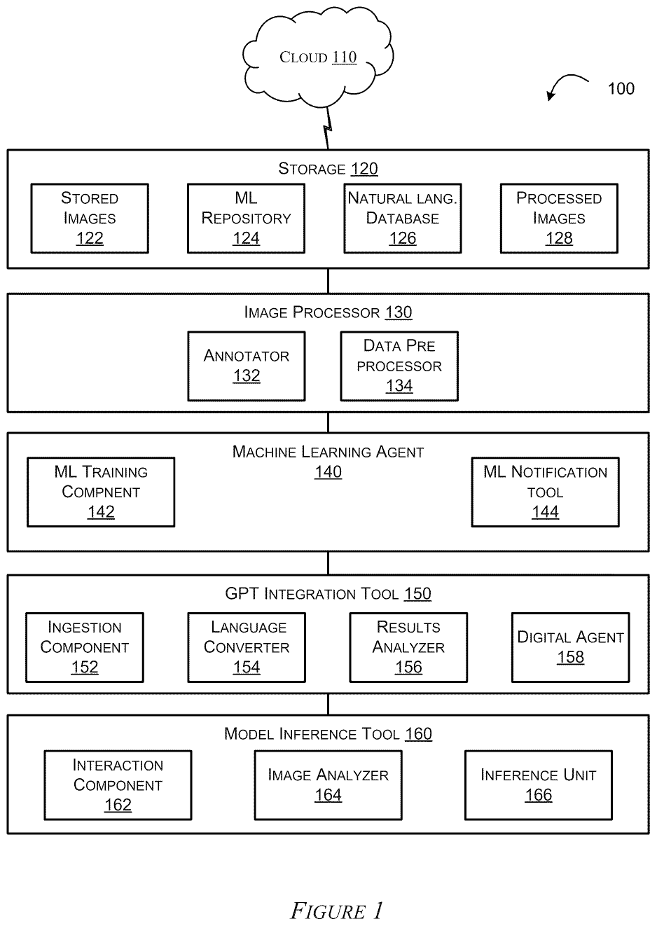

Referring now to FIG. 1, a block diagram of an example machine learning pipeline system 100 suitable for use in implementing embodiments of the disclosure is shown. The machine learning pipeline system 100 is configured to facilitate dataset preparation and machine learning development using interactive tools. The machine learning pipeline system 100 can utilize stored images and convert those images into a training dataset based on selections and project-specific requirements provided by a user. Once created, the training dataset can be used to train a machine learning model to accurately make predictions based on the needs of the project. The developed model can be integrated into a machine learning repository that can be used to assist users in making predictions on inputted images and determining the type of machine learning model to use in a later developed project. Embodiments of the machine learning pipeline system 100 can also integrate into collaboration platforms, allowing users to provide questions or statements to which the machine learning pipeline system 100 can respond and provide additional insights into specific projects or suggestions on how a user can proceed further.

In some implementations, the machine learning pipeline system 100 generates a user interface onto a display, where the user interface has selection fields associated with a machine learning project. The selection fields can include drop-down menus, radio button selections, multi-select list boxes, and the like. These selection fields can include machine learning selections that can assist users in creating a project-specific model. Once the selections are made, the machine learning pipeline system 100 initializes the machine learning project based, at least partially, on the machine learning selections and trains a machine learning model associated with the machine learning project using annotated training data. Once created, the machine learning pipeline system 100 can integrate the machine learning model into a computing environment on a production system associated with the machine learning project.

The machine learning pipeline system 100 can be implemented as a standalone application or as part of another application or suite of applications. For example, the machine learning pipeline system 100 can be implemented as part of a machine learning application, enabling the machine learning development and deployment to be a module of a machine learning application suite. Alternatively, once the machine learning pipeline system 100 produces a deployable machine learning model, that model can be provided to an object detection application or project for implementation.

As an exemplary implementation and operation of the machine learning pipeline system 100, an environment is setup that establishes a direct linkage between the various components including a cloud 110, a storage 120, an image processor 130, a machine learning agent 140, a Generative Pre-Trained Transformer (GPT) integration tool 150, and a model inference tool 160. The storage 120 includes stored images 122, a machine learning repository 124, a database 126, and processed images 128. The image processor 130 includes an annotator 132 and a dataset preprocessor 134. The machine learning agent 140 includes a machine learning component 142 and a machine learning notification tool 144. The GPT integration tool 150 includes an ingestion component 152, a natural language convertor 154, a results analyzer 156, and a digital agent 158. The model inference tool 160 includes an interaction component 162, an image analyzer 164, and an inference unit 166.

In some implementations, the environment setup includes steps where the machine learning pipeline system 100 installs necessary software dependencies, allowing for interactions with cloud-based services (e.g., remote storage, computations, databases, and images). The software dependencies can include adding or installing required software packages or libraries that the machine learning pipeline system 100 requires to function properly with a particular cloud-based service or servicer. These dependencies can be external packages or tools that are not built into a language or environment but are required for specific tasks. These software dependencies include packages such as Amazon Web Services (AWS) Software Development Kit (SDK) for Python (boto3), pymysql, OpenCV (cv2), Pillow (PIL), and the like. OpenCV for instance, is a widely used open-source computer vision library that offers tools for image and video processing. It can include functions for image manipulation, object detection, and feature extraction.

In some implementations, the machine learning pipeline system 100 includes generating a user interface for a device that allows a user to interact with the various functions provided by the machine learning pipeline system 100. These interactions can occur through the use of a keyboard, a mouse, a microphone, et cetera. In some embodiments, the user interface may be integrated with the display to present a touchscreen.

The user interface can include elements like drop-downs, sliders, text boxes, and buttons that can be added to allow users to interact with the machine learning pipeline system 100. These elements allow users to make selections and provide input that can modify or configure dataset paths, model parameters, project settings, and the like. For instance, users can choose which dataset they want to use for training. Users can also specify training parameters like the size of the model (e.g., small, medium, large), number of epochs (training iterations), batch size, learning rate, and the like. The interface also allows users to choose whether to create a new project or continue with an existing project by inputting project-specific details.

Based on the input provided by the user, the machine learning pipeline system 100 can set global variables that determine configurations for model training, including dataset paths, model dimensions, training epochs, and other user-defined variables. Mode dimensions, for example, allow users to set parameters like the number of layers, neurons, or the type of architecture for the model (e.g., convolutional neural network (CNN), Recurrent Neural Network (RNN)).

The user interface provided by the machine learning pipeline system 100 allows for the training process to be customized based on the user's needs for each specific project or experiment. For example, if a user selects a larger model or more training epochs through the interface, the corresponding variables (like model size and number of epochs) are automatically updated to reflect those choices. Setting these variables dynamically based on user input improves model development because different projects may require different configurations. It ensures that each training run is tailored to the user's specific goals, whether they are experimenting with different datasets or trying various model configurations.

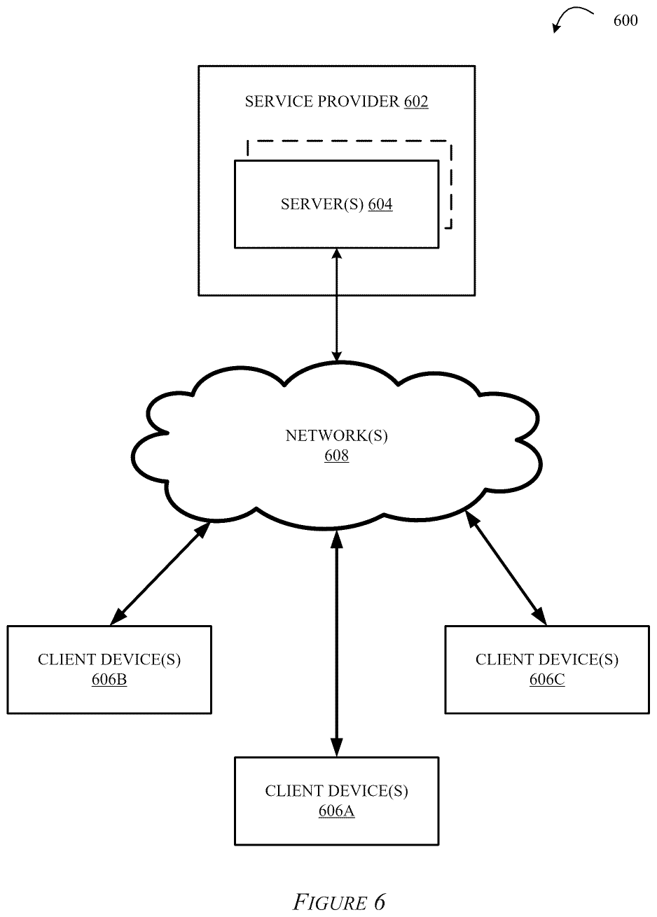

The cloud 110 is a wireless communication network of remote servers hosted on the Internet to store, manage, and process data rather than relying on local servers or personal computers. According to some aspects, the cloud 110 can be an example of a wireless local area network (WLAN), such as a Wi-Fi network. In some other examples, the cloud 110 can be an example of a cellular radio access network (RAN), such as a 5G or 6G RAN that implements one or more cellular protocols. In some examples, the cloud 110 can be embodied in a computing environment, such as the computing environment 600 of FIG. 6.

As illustrated in FIG. 1, the machine learning pipeline system 100 includes the storage 120. The storage 120 is a component used to store and retrieve data in both temporary and permanent forms and maintains data of any type, size, or kind as necessary to perform the function of the machine learning pipeline system 100. The storage 120, as shown in FIG. 1, includes stored images 122 that can include images associated with various projects that may or may not have undergone any form of pre-processing, filtering, or compression. These images can contain the original pixel data captured by the imaging devices (like a camera or sensor).

The storage 120 also includes a machine learning repository 124, which is a centralized platform or database where datasets, models, tools, and other resources are stored, shared, and made available to users. The machine learning repository 124 can include pretrained models that have already been trained on datasets an can be reused for similar tasks. These models can be fine-tuned or adapted to new tasks with additional training. For example, the machine learning repository 124 can include models like ResNet, VGG, and EfficientNet, as well as models trained by machine learning pipeline system 100.

The storage 120 further includes a natural language database 126 used to respond to user inquiries. In some implementations, the database 126 is a MySQL database, which is a relational database management system (RDBMS) that stores structured data in the form of tables with rows and columns. The natural language database 126 can include information related to the machine learning projects, including models, datasets, training results, metadata, and configurations.

As described further below, users can ask questions related to machine learning models or projects, and the machine learning pipeline system 100 can generate and execute queries against the natural language database 126 to retrieve relevant information. The information stored in the natural language database 126 can include model metadata such as model names, architectures, and training parameters. It can also store project details such as datasets used and evaluation metrics, as well as logs or results such as performance metrics and model accuracy.

The storage 120 also includes processed images that the image processor 130 pre-processes for use in machine learning training, as well as processed images where a trained machine learning model provided its predictions.

In some implementations, the storage 120 is connected over the cloud 110, where the data is stored remotely and accessible by the machine learning pipeline system 100. In such implementations, datasets stored over the cloud 110 can be accessed and read, and output models and logs can be stored without the need to store such files locally.

In implementations, the image processor 130 receives stored images 122 or images provided by a user. As discussed further below, the image processor 130 operates and provides a series of techniques and transformations applied to images to prepare them for use in machine learning model training. These techniques extract useful information from the raw image data so that models can learn meaningful patterns and features from the data.

The image processor 130 includes an annotator 132 configured to annotate and label the images. In some implementations, the annotator uses artificial intelligence techniques to automatically pre-label the images. The annotator 132 is configured to learn from previous annotations and generate predictions for new data points, allowing users to start with pre-labeled images during the annotation process a user may conduct. As the images are annotated, embodiments of the image processor 130 utilize machine learning techniques to learn from these changes in real-time, continuously improving its predictions and adapting to the annotations specific to a project.

The annotator 132 is further configured to provide various annotation modes, including bounding box annotation, polygon annotation, semantic segmentation, instance segmentation, and keypoint annotation. For example, polygon annotation is a method where the shape of an object is defined using a series of connected points that form a close polygon around the object of interest. Bounding box annotation, as another example, is a technique where objects within an image are marked by drawing a rectangular box around them. This type of annotation assists in identifying the location of objects in an image so that those objects can be used to train machine learning models.

The image processor 130 further includes a data preprocessor 134 used to apply various techniques to enhance image quality, standardize input dimensions, and optimize the dataset for model training. These techniques include resizing, normalization, image cropping, color space conversion, image denoising, histogram equalization, gamma correction, edge detection, image binarization (thresholding), padding, data format conversion, channel manipulation, and image compression.

As an example, depending on the application, the color space of the image may need to be changed. For example, converting an image from Red-Green-Blue (RGB) to grayscale may be useful when color information is not relevant to the task. Histogram equalization, as another example, enhances the contrast of an image by spreading out the most frequent intensity values. This technique can redistribute pixel intensity values so that the image has a more uniform distribution of brightness levels, improving the visibility of certain features.

In some implementations, the data preprocessor 134 allows for user input to modify and select the various techniques applied to an image. As such, users can select techniques such as resizing, normalization, augmentation, noise reduction, color space conversion, and edge detection. Based on the type of project and its needs, the data preprocessor 134 can ensure that images are in the correct format, size, and quality, making it easier for the machine learning model to learn effectively and generalize well.

The machine learning agent 140 is capable of, configured to, or operable to provide machine learning models and techniques that are trained to provide predictions associated with a selected project. Some processes, methods, operations, techniques, or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in a system to enhance various aspects associated with project-specific object detection. For example, an AI/ML model may be trained to identify patterns or relationships in data observed in camera data and/or sensor data to detect aspects of the items during an operation performed at a factory.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. For example, an AI/ML model operating on input data may start at an initial output based on the biases and then update the output based on a combination of the input data and the weights.

In some examples, AI/ML models may be downloadable. For example, AI/ML model components may be shared with the machine learning pipeline system 100. The machine learning pipeline system 100 may download the AI/ML model and use the model to make decisions related to a specific project.

In some implementations, the machine learning training component 142 can train and provide machine learning models in the form of convolutional neural networks (CNNs), region-based CNNs (R-CNNs), Recurrent Neural Networks (RNNs) and Long Short-Term Memory Networks (LSTMs), Transformers, Semantic Segmentation Models, 3D CNNs (3D-CNNs), Point Cloud Processing Models, Sensor Fusion Models, and the like. The machine learning training component 142 is further operable to utilize frameworks such as TensorFlow, PyTorch, Keras, and OpenCV. Libraries such as TensorFlow Object Detection API, Detectron2, and Open3D can also be used. The models and techniques trained and provided by the machine learning training component 142 can be tailored to specific steps along a process required by the project, such as providing varying solutions for detecting items, defects, and determining their positioning using camera and sensor data.

Once a model is trained and evaluated, the machine learning notification tool 144 can populate information associated with the process to the natural language database 126 as well as provide notice to the user that the training is complete, as well as the metrics associated with the training and evaluation. If the results are acceptable for the needs of a project, then the trained model can be added to the machine learning repository for later access.

As further illustrated in FIG. 1, the machine learning pipeline system 100 includes the GPT integration tool 150 that integrates natural language processing, database querying, and machine learning to dynamically respond to user inquiries. The GPT integration tool 150 is used to analyze questions and provide insights by interacting with the machine learning repository 124 and the natural language database 126.

The ingestion component 152 of the GPT integration tool 150 is triggered when a user sends a question or text string to the machine learning pipeline system 100. In some implementations, messages can be entered via a collaboration and communication platform such as Slack, which is associated and linked with the machine learning pipeline system 100. The ingestion component 152 can extract the text of the user's questions and perform a relevance check. The relevance check can first check if the question is relevant to the information contained in the machine learning pipeline system 100. This check ensures that only questions that pertain to the stored data are processed further.

If the ingestion component 152 determines that the question or text string is relevant, then the ingestion component 152 pre-processes the string by removing any platform-specific commands or mentions (e.g., @user tags) or other platform-specific formats.

Once the user text is processed, the language converter 154 can convert that natural language into SQL. Initially, the language converter 154 parses the natural language question by identifying the key components such as the entities (e.g., table names or fields in the database 126), relationships between them, and the kind of information the user is seeking (e.g., retrieving data, aggregating, or filtering). For example, a user may enter a question such as “What are the top 5 machine learning models with the highest accuracy for an object identification project?” The language converter 154 can identify that the user is asking for models, an ordered ranking based on accuracy, and a limit of 5 results.

Based on the parsed questions, the language converter 154 then converts the natural language into one or more SQL queries. In some implementations, the language converter 154 utilizes a GPT and feeding the GPT the schema description of the natural language database 126. The schema description can include details such as the tables, columns, and relationships within the database. The GPT can then use this information to generate SQL queries that match the user's question.

The results analyzer 156 then processes the results from the SQL query and converts them into a detailed, context-aware natural language response using a GPT. In some implementations, the results analyzer 156 also checks that the user's question is relevant and appropriately scoped to the database.

In some embodiments, the results analyzer 156 analyzes the SQL query results using another GPT call. Once the SQL query has been executed and results are returned, a GPT call is used again to convert the raw query results into a natural language response that the user can easily understand. The GPT model can take into account several factors, such as the database schema description, the original user question, the generated SQL query, and the query results. Taking these factors into account can ensure that the response is both accurate and relevant to the user's inquiry.

As an example, a user may pose a question such as “What are the top 3 machine learning models with the highest accuracy?” The SQL query result will return a table such as:

| Model Name | Accuracy |
|---|---|
| Model_X | 0.98 |
| Model_Y | 0.95 |
| Model_Z | 0.93 |

The results analyzer 156 can input the query result into a GPT that may output a response such as “The top 3 machine learning models in the machine learning pipeline system 100 based on accuracy are Model X with an accuracy of 98%, Model Y with 95%, and Model Z with 93%.”

In some embodiments, the results analyzer 156 validates the user's question to ensure it is relevant to the scope of the database and contains the necessary keywords or context related to the available data before generating the final response. In some implementations, the results analyzer 156 checks if the user's question pertains to the database 126 by looking for specific keywords or terms related to the models, projects, or attributes that the database stores (e.g., “models,” “accuracy,” “training”). If the question is out of scope or unrelated to the database (e.g., “What's the weather like tomorrow?”), then the results analyzer 156 can respond with an error or ask the user to refine their query. Once a response is generated, the GPT integration tool 150 can then provide the result to the user directly or via the collaboration or communication platform the user used to pose the question.

The digital agent 158 of the GPT integration tool 150 is configured to actively monitor edge systems with deployed models. For instance, if a model produces a ‘low confidence’ result, the digital agent 158 can trigger and respond to the event. In such cases, the digital agent 158 initiates tasks like using incident images for future training or requesting additional frames and data, such as audio, PLC states, and sensor inputs, to acquire additional training material to improve model accuracy. In some implementations, the digital agent 158 facilitates the synthetic generation of training images (e.g., stored images 122) that can enhance the dataset size and quality to improve model performance with minimal reliance on manually collected data.

In some implementations, the digital agent 158 monitors the health of deployed models in real-time by analyzing performance metrics to identify anomalies and alerting support staff as needed. Simultaneously, the digital agent 158 can automate the collection of data, such as incident images and logs, to streamline the iteration process for future model updates. In some embodiments, when a new model version is ready for deployment, the digital agent 158 can manage the deployment by instructing edge systems to download the update. The digital agent 158 can configure the edge systems to operate exclusively with the new model or run both the new and the old versions concurrently to compare the results. By automating these processes, the digital agent 158 improves operation by reducing the time and effort required to refine and redeploy models, ensuring consistent optimization.

As further illustrated in FIG. 1, the machine learning pipeline system 100 includes the model inference tool 160 that allows users to process and analyze images directly and, in some implementations, through a collaboration and communication platform. Users can upload images, such as project-specific images, and receive an analysis from the machine learning models stored in the machine learning repository 124.

The interaction component 162 handles user messages and inputs and determines whether specific action (e.g., image processing) needs to be triggered. When a user sends a message to the machine learning pipeline system 100 either directly or via a collaboration and communication platform, the interaction component 162 checks the content of the message to determine whether any specific actions are required. If a message includes an image or file, the interaction component 162 can trigger another function designed for image processing.

Based on the message content, the interaction component 162 can decide whether to proceed with further processing or not. If an image or other media is attached, it triggers the image analyzer 164. Otherwise, the interaction component 162 terminates if no action is required.

The image analyzer 164 is configured to handle the actual processing of images provided by the user, including verifying file formats and uploading them to the storage 120 for further use. In some embodiments, when a file (such as an image) is shared by the user, the image analyzer 164 verifies that the file is an image and has not been processed previously. The image analyzer 164 can check the file's metadata (e.g., file type, size) to ensure it is an image and confirm whether it has been processed before to avoid redundant work. For example, a user uploads an image to the machine learning pipeline system 100. From there, the image analyzer 164 detects the format of the image to confirm it is an image (e.g., JPG, PNG) and also checks the storage 120 for duplicates of the image.

In some embodiments, the image analyzer 164 includes unsupported format handling. If the file is an unsupported format (e.g., HEIC), the image analyzer 164 can convert it to a supported format (e.g., JPEG, PNG) before proceeding with the rest of the image processing. In some implementations, when the image analyzer 164 detects an unsupported format, it can use an image processing library (e.g., ImageMagick or Pillow) to convert the image. If the conversion fails, the image analyzer 164 can produce a notification that notifies the user of the error.

Once the image is converted or if no conversion is necessary, the image analyzer can utilize the functionality provided by the data preprocessor 134 to process the image as needed, including resizing, adjusting quality, and preparing it for further use (e.g., uploading the image to the storage 120.

The inference unit 166 performs classification, model selection, object detection, and post-processing when an image is uploaded by a user. Once classified, the inference unit 166 can upload the image to storage 120 and notify the user either directly or via a collaboration and communication platform. In some embodiments, when the image analyzer 164 uploads an image to storage 120, the inference unit 166 performs multiple tasks, including classifying the image, selecting a model for object detection, running the object detection process, and post-processing the results.

In some implementations, the inference unit 166 classifies the image and identifies the project of origin for the image based on its content (e.g., objects detected, scene, background elements). In some embodiments, the inference unit 166 utilizes a platform of computer vision models that can be used to classify the image and identify the contents within the image. Based on the object, a model can classify the image as a particular project associated with the machine learning pipeline system 100.

Once the project of origin is determined, the inference unit 166 selects the most appropriate model from the machine learning repository 124 for detailed object detection. In some embodiments, the inference unit 166 selects the most recently trained model associated with a project, ensuring that the latest and most optimized version of the model is used. From the project detected by the platform, the inference unit 166 can retrieve metadata of the available models to determine the optimal model to use.

The inference unit 166 is further configured to utilize the selected model on the image to perform object detection. The model can process the image and output predictions for detected objects, including their class label and bounding box coordinates. After the objects are detected, the inference unit 166 can perform post-processing to visually mark and annotate the detected objects. Post-processing prepares the image for presentation, adding the bounding boxes and labels to highlight the objects detected in the image.

The inference unit 166 is further configured to upload the processed image (with annotated objects) to the user and, in some embodiments, send a notification to the user via a collaboration and communication platform.

It is noted that FIG. 1 is intended to depict the major representative components of a machine learning pipeline system 100. In some embodiments, however, individual components may have greater or lesser complexity than, as represented in FIG. 1, components other than or in addition to those shown in FIG. 1 may be present, and the number, type, and configuration of such components may vary.

Each component 110-160 of the machine learning pipeline system and their corresponding elements (as shown in FIG. 1) can be in communication with one another using suitable communication technologies. It will be recognized that although components 110-160 are shown to be separate in FIG. 1, any of the components 110-160 and their corresponding elements can be combined into fewer components, such as into a single facility or module, divided into more components, or configured into different components as can serve a particular embodiment.

The components 110-160 and their corresponding elements can comprise software, hardware, or both. For example, the component 110-160 and their elements can comprise one or more instructions stored on a computer-readable storage medium and executable by processors of one or more computing devices. When executed by the one or more processors, the computer-executable instructions of the machine learning pipeline system 100 can cause a client device and/or a server device to perform the methods described herein. Alternatively, the component 110-160 and their corresponding elements can comprise hardware, such as a special-purpose processing device, to perform a certain function or group of functions. Additionally, the components 110-160 and their corresponding elements can comprise a combination of computer-executable instructions and hardware.

Furthermore, the components 110-160 of the machine learning pipeline system 100 can, for example, be implemented as one or more standalone applications, as one or more modules of an application, as one or more plug-ins, as one or more library functions or functions that can be called by other applications, and/or as a cloud-computing model. Thus, the components 110-160 of the machine learning pipeline system 100 can be implemented as a standalone application, such as a desktop or mobile application. Furthermore, the components 110-160 of the machine learning pipeline system 100 can be implemented as one or more web-based applications hosted on a remote server.

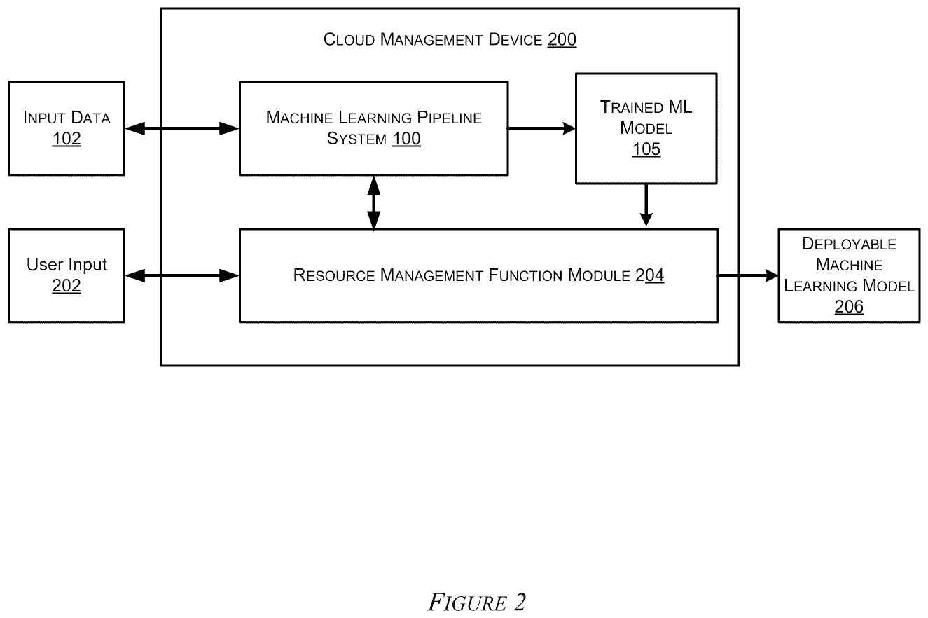

Referring now to FIG. 2, FIG. 2 illustrates an example of a cloud management device 200 for managing and provisioning machine learning development tools operating in a computing environment (e.g., a data center, cloud computing environment, cloud computing architecture), in accordance with embodiments of the present disclosure. As discussed, the techniques described herein enable a machine learning pipeline system 100 to facilitate the development and deployment of machine learning models. Accordingly, in some embodiments, a computing environment can provide image data 102 to the machine learning pipeline system 100, train a machine learning model, and produce classifications designed for a specific project. The trained machine learning models 215 can relate to the user input 202 associated with a particular computing environment and project. As shown in FIG. 2, in some configurations, the machine learning pipeline system 100 is implemented as part of a cloud management device 200. In other configurations, the machine learning pipeline system 100 is implemented as a separate system that provides at least the trained machine learning models 215 to the cloud management device 200 to be implemented onto the microservices managed by the cloud management device 200.

Once the trained machine learning models 215 sufficiently produce classifications of images for a specific project in a computing environment and has been obtained by the cloud management device 200, the trained machine learning models 215 can be edited and/or implemented by the cloud management device 200. For example user input 202 can be received by a resource management function module 204 of the cloud management device 200. The user input 202 includes selections and project-specific details that can be used to refine or modify the machine learning models produced by the machine learning pipeline system 100. The selections can represent choices such as dataset selection, data pre-processing selections, model architecture selections, hyperparameter selections, feature selections, training strategy, evaluation metrics selections, data balancing techniques augmentation and regularization, and the like. Additionally, the user input 202 can also include requirements and/or restrictions when producing a trained machine learning model 215. The resource management function module 204 can analyze the trained machine learning models 215 and the user input 202 to further refine a model or to have the machine learning pipeline system 100 produce a new model based on the user input 202. Once the resource configuration editing is complete, the deployable machine learning model 206 is outputted and can be used to classify images in a computing environment for a specific project.

Thus, the illustrative embodiments in FIGS. 1 and 2 and described herein, provide various improvements over conventional methods. For example, embodiments offer an efficient and user-friendly approach to object detection model training. By leveraging cloud-based resource utilization for project management and storage and metadata handling, the machine learning pipeline system 100 takes advantage of cloud offerings, allowing for cost-effective and scalable resource use. Additionally, embodiments improve upon automation and efficiency by reducing manual labor and speeding up the dataset preparation process, which can be time-consuming in complex manufacturing and packaging use cases. The automated dataset conversion and organization further streamline the workflow, ensuring that the data is ready for training without manual intervention. The use of a user interface for project configuration also allows users to interactively set training parameters without modifying the code. This flexibility makes the pipeline more accessible, customizable, and efficient for users of varying skill levels.

The machine learning pipeline system 100 further improves upon technology by seamlessly integrating model training, evaluation, and conversion for deployment on edge devices, making the transition from model development to real-world application faster and more efficient. Real-time notifications and collaboration features also allow for real-time updates and collaboration, keeping team members informed of training progress, model performance, and available resources, thereby improving productivity and communication.

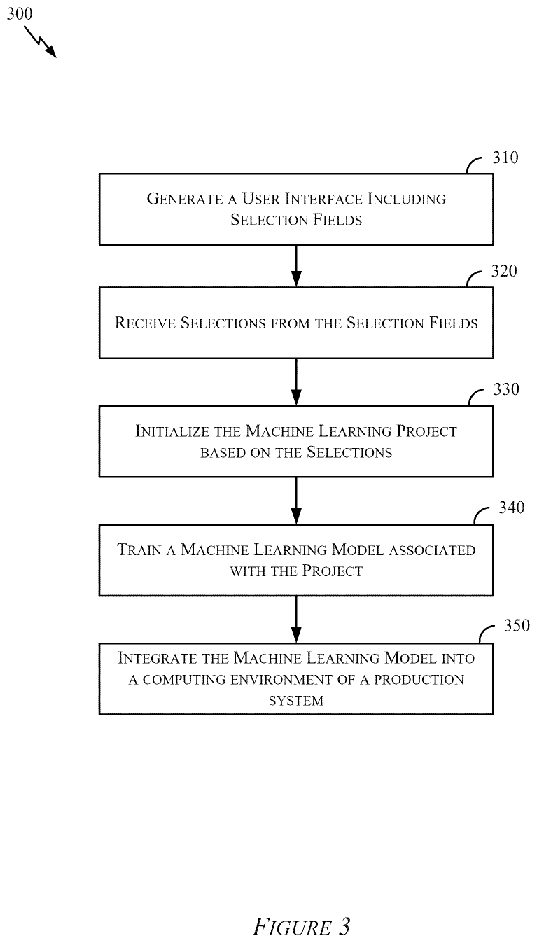

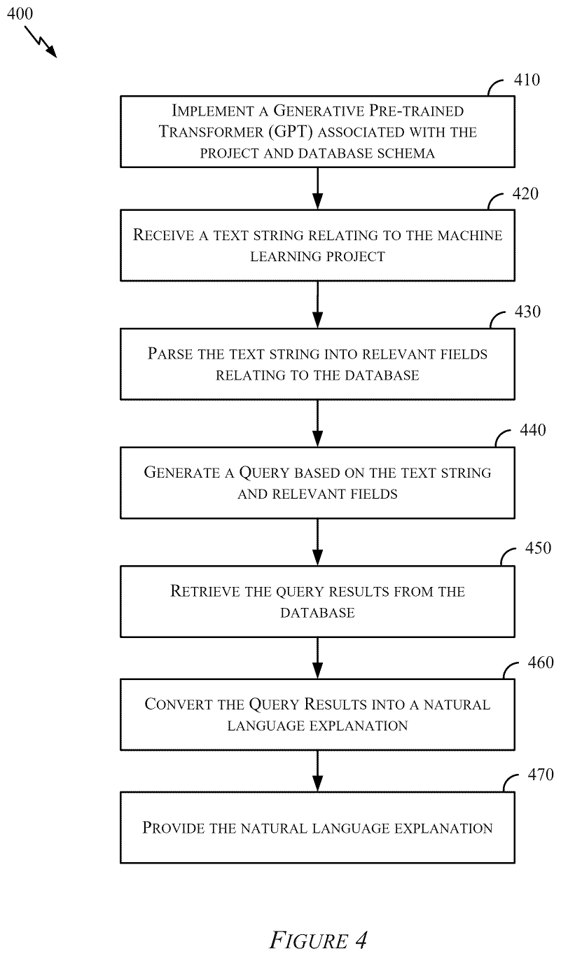

In addition to the foregoing, embodiments can also be described in terms of flowcharts comprising acts and steps in a method for accomplishing a particular result. For example, FIGS. 3 and 4 illustrate flowcharts of exemplary methods in accordance with one or more embodiments. The methods described in relation to FIGS. 3 and 4 can be performed with fewer or more steps/acts or the steps/acts can be performed in differing orders. Additionally, the steps/acts described herein can be repeated or performed in parallel with one another or in parallel with different instances of the same or similar steps/acts.

### Example Flow Diagrams

FIGS. 1 and 2, the corresponding text, and the examples provide a number of different systems that provide deployment of project-specific machine learning models using interactive configurations. In addition to the foregoing, embodiments can also be described in terms of flowcharts comprising acts and steps to accomplish a particular result. For example, FIG. 3 illustrates a flowchart of an exemplary method in accordance with one or more embodiments. The method described in relation to FIGS. 3, 4, and 5 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 3, a flow diagram illustrating a method is provided. Each block of the method 300 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

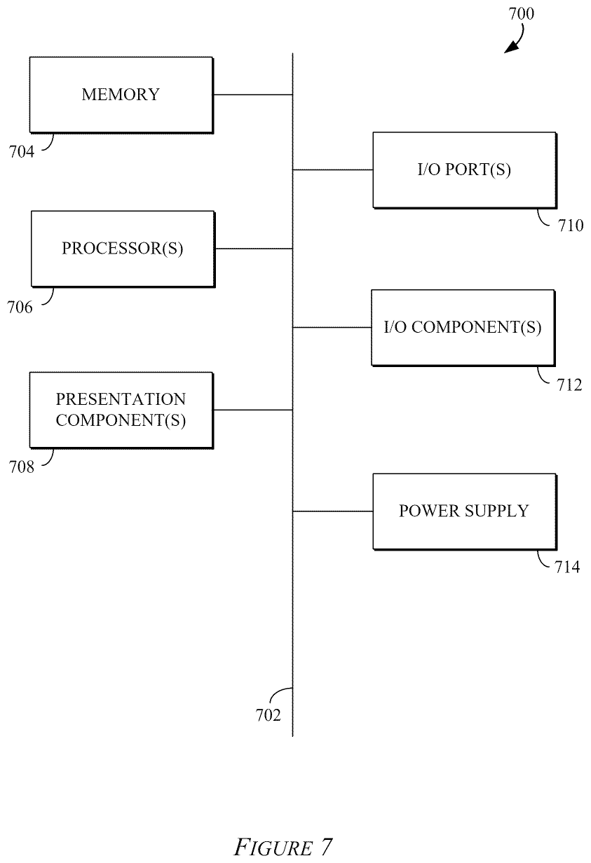

FIG. 3 shows a flowchart illustrating an example process 300 performable by or at a computing device that supports optimizing deployment of project-specific machine learning models using interactive configurations. For example, the process 300 may be performed by a computing device, such as the wireless computing device 700 described with reference to FIG. 7. In some examples, the process 300 may be performed within a computing environment such as the computing environment 600 described with reference to FIG. 6.

In some examples, the computing device is configured to perform the process 300 described with reference to FIG. 3. At block 310, the computing device generates a user interface that includes selection fields associated with a machine learning project onto a display. The user interface selection fields offer selections through which the user provides the input representing preferences relating to the configuration and architecture of a machine learning model associated with the project, as discussed above. For example, the user interface enables the user to specify training parameters like the size of the model (e.g., small, medium, large), number of epochs (training iterations), batch size, learning rate, and the like.

In some embodiments, the interface also allows users to choose whether to create new project or continue with an existing project by inputting project-specific details. In some embodiments, the user interface can enable a user to link a computing device, such as a desktop, laptop, or other hardware, to upload images and provide them to the machine learning pipeline system 100. In some embodiments, the user interface also enables the user to provide a specific configuration for a machine learning model requested by the user. Alternatively, as discussed above, the user interface allows the user to edit and refine models already trained by the machine learning pipeline system, which can be edited in a cloud management device separate from the machine learning pipeline system 100.

At block 320, the computing device receives the selections from the selections fields displayed on the display. As discussed, these selections can also include global variables that determine configurations for model training, including dataset paths, model dimensions, training epochs, and other user-defined variables.

At block 330, the computing device initializes the machine learning project based, at least in part, on the selections received. In some implementations, initializing the project includes creating necessary folders and directories for storing datasets, labels, and other project-related assets. If the selections indicate that the machine learning project is not new, then updates to the existing project are performed by adding new datasets and/or labels. If a new project is initialized, the computing device can create directories, both locally and in the cloud, for different datasets, model checkpoints, and logs. In some embodiments, for cloud-based storage, the computing device ensures that the directory structure is mirrored in the cloud and synchronizes files between local storage and the cloud.

In some embodiments, depending on the dataset being used to train a machine learning model, the initialization includes converting the dataset to a format compatible with the machine learning pipeline system 100. For instance, the conversion can convert XML files to .txt files. In some implementations, initialization includes validating the dataset by ensuring that every image in the dataset has a corresponding annotation file. A check for corrupted images or mismatches in the dataset can also be performed. The computing device can also organize the dataset into training, validation, and test splits, with the files moved into corresponding folders for proper structuring.

At block 340, the computing device trains a machine-learning model associated with the selections and the machine-learning project. The machine learning model can be trained to provide project-specific object detection for an assigned task. In some implementations, the computing device incorporates user-specified selections and parameters such as batch size, number epochs, learning rate, and dataset paths. Once configured, the computing device can train the machine learning model using a project-specific dataset and monitor the training process by capturing the standard output and standard error streams in separate logs.

Once training is complete, the computing device evaluates the machine learning model by analyzing its performance metrics. Various techniques, such as Average Precision (mAP) at different intersections over Union (IoU) thresholds, can be used to evaluate the model. Following the evaluation, the computing device converts the machine learning model into a format compatible with a computing device associated with the machine learning project, such as devices used in edge computing. This conversion can integrate the model into a pipeline where it can be deployed on devices like cameras for real-time object detection.

At block 350, the computing device integrates the converted machine learning model into a computing environment of a production system associated with the machine learning project. As discussed, the converted model is capable of being integrated into deployed devices associated with the project.

FIG. 4 shows a flowchart illustrating an example process 400 performable by or at a computing device that supports providing natural language explanations for questions related to machine learning projects. For example, the process 400 may be performed by a computing device, such as the wireless computing device 700 described with reference to FIG. 7. In some examples, the process 400 may be performed within a computing environment such as the computing environment 600 described with reference to FIG. 6.

In some examples, the computing device is configured to perform the process 400 described with reference to FIG. 4. At block 410, the computing device implements a GPT configured to respond to inquiries associated with the machine learning project and other related projects using a database schema of the database used to store metadata of the machine learning models. The database schema is provided as input to GPT to give it an understanding of the structure of the database. This schema might include table names, column names and data types, relationships between tables (foreign keys, etc.), and any relevant metadata, such as what each table or column represents (e.g., a “project_updates” table might contain updates on machine learning projects).

At block 420, the computing device receives a text string that may be a question in a natural language relating to the machine learning project or other related projects. In some implementations, the text string is received from a collaboration and communication platform (e.g., Slack). Once received, at block 430, the computing device parses text string into relevant fields relating to the database. In some implementations, the computing device performs a relevance check to see if the question pertains to the machine learning model data stored in the database (e.g., checking for keywords like “project,” “models,” or “updates”). In some implementations, the computing device pre-processes the text string by removing unnecessary mentions or formatting from the collaboration and communication platform.

In some implementations, the computing device parses the text string using a GPT to analyze the question and understand the intent. For example, the text string “What are the most recent updates in the X123 machine learning project?” might translate to “fetch the latest records from the updates table.” From there, relevant fields, such as “records” and “updates tables,” can be selected.

At block 440, the computing device generates a query readable by the database. In some implementations, the computing device utilizes a GPT with knowledge of the database schema to generate an appropriate query. At block 450, the computing device retrieves the query results by executing the query against the database. In some implementations, the computing device can establish a connection with the database using credentials stored in the cloud and execute the query. After the results are returned, the computing device validates the results to ensure that it does not perform any harmful operations (e.g., drop, delete). In some embodiments, validation can be performed using regex checks for forbidden commands.

At block 460, the computing device converts the query results into a natural language explanation. In some embodiments, the computing device utilizes a GPT to generate a detailed, natural language response. The GPT can use the user's questions in the text string, the query result, and the database schema to form a coherent, human-readable answer.

At block 470, the computing device provides the user with a natural language explanation. In some embodiments, the computing device checks for any forbidden or sensitive content in the response. For example, strings that include the words ‘confidential’ or ‘sensitive’ may include forbidden information. When such instances occur, the computing device may remove that portion of the natural language explanation or provide a notice to the user that the response cannot be shown due to the detection of forbidden information included in the response.

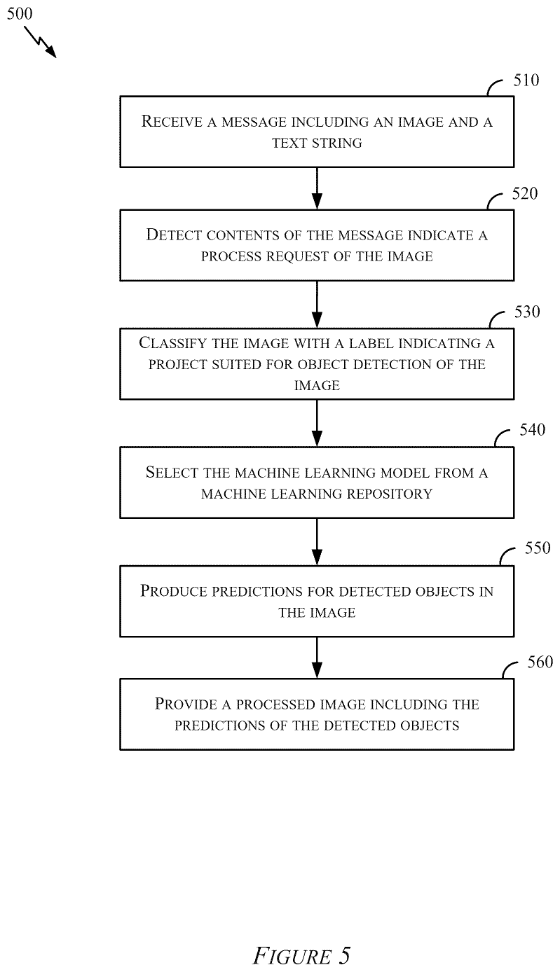

FIG. 5 shows a flowchart illustrating an example process 500 performable by or at a computing device that supports providing inferences to user-provided images using machine learning models stored in a machine learning repository. For example, the process 500 may be performed by a computing device, such as the wireless computing device 700 described with reference to FIG. 7. In some examples, the process 500 may be performed within a computing environment such as the computing environment 600 described with reference to FIG. 6.

In some examples, the computing device is configured to perform the process 500 described with reference to FIG. 5. At block 510, the computing device receives a message including an image and text string. The image can relate to a project or any other image that requires analysis or inference. For example, a user uploads a project-related image, such as a screenshot of an object detection task or a general photo for analysis. The computing device captures the image transmitted by a collaboration and communication platform and initiates the inference process.

At block 520, the computing device detects the contents of the message and determines that the content requires a process request of the image. In some implementations, the computing device verifies the message contents (e.g., image or text) and determines whether image processing should be initiated. If the message is irrelevant (e.g., no image present in the message), it terminates without further action.

In some implementations, the computing device performs file event checking by checking whether the uploaded image is an image and ensures that the image has not been previously processed. If the image is an unsupported format, the computing device can either convert it to a supported format or notify the user about the unsupported format. In some implementations, the computing device processes the image by resizing and adjusting in terms of quality before being sent for classification.

At block 530, the computing device classifies the image with a label indicating a project suited for object detection of the image. The computing device uses a machine learning model that classifies the image to determine which project or category it belongs to. In some implementations, a machine learning model such as Roboflow or another classification model that recognizes the scene or context of the image is used.

At block 540, the computing device selects the machine learning model based on the initial classification. At block 550, using the selected model, the computing device produces predictions by performing object detection on the image. Object detection can identify objects, their classes, and their locations within the image. In some implementations, the computing device performs post-processing on the image by highlighting and annotating the detected objects on the image. This step can involve drawing bounding boxes around detected objects and adding labels to describe what each object is. At block 560, the computing device provides the processed image, including the predicted objects, to the user.

### Example Computing Environment

FIG. 6 illustrates a schematic diagram of an exemplary computing environment 600 in which the machine learning pipeline system 100 can operate in accordance with one or more embodiments of the present disclosure. In one or more embodiments, the computing environment 600 includes a service provider 602, which may include one or more servers 604 connected to a plurality of client devices 606A-606C via one or more networks 608. The client devices 606A-606C, the one or more networks 608, the service provider 602, and the one or more servers 604 may communicate with each other or other components using any communication platforms and technologies suitable for transporting data and/or communication signals, including any known communication technologies, devices, media, and protocols supportive of remote data communications, examples of which will be described in more detail below with respect to FIG. 7.

Although FIG. 6 illustrates a particular arrangement of the client devices 606A-606C, the one or more networks 608, the service provider 602, and the one or more servers 604, various additional arrangements are possible. For example, the client devices 606A-606C may directly communicate with the one or more servers 604, bypassing the network 608. Or alternatively, the client devices 606A-606C may directly communicate with each other. The service provider 602 may be a public cloud service provider which owns and operates its own infrastructure in one or more data centers and provides this infrastructure to customers and end users on demand to host applications on the one or more servers 604. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 604 may similarly include one or more hardware servers, each with its own computing resources, which are divided among applications hosted by the one or more servers for use by members of the organization or their customers.

Similarly, although the computing environment 600 of FIG. 6 is depicted as having various components, the computing environment 600 may have additional or alternative components. For example, the environment 600 can be implemented on a single computing device with the machine learning pipeline system 100. In particular, the machine learning pipeline system 100 may be implemented in whole or in part on the client device 606A.

As illustrated in FIG. 6, the environment 600 may include client devices 606A-606C. The client devices 606A-606C may comprise any computing device. For example, client devices 606A-606C may comprise one or more personal computers, laptop computers, mobile devices, mobile phones, tablets, special purpose computers, or other computing devices, including computing devices described below with regard to FIG. 7. Although three client devices are shown in FIG. 6, it will be appreciated that client devices 606A-606C may comprise any number of client devices (greater or smaller than shown).

Moreover, as illustrated in FIG. 6, the client devices 606A-606C and the one or more servers 604 may communicate via one or more networks 608. The one or more networks 608 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 608 may be any suitable network over which the client devices 606A-606N may access service provider 602 and server 604, or vice versa. The one or more networks 608 will be discussed in more detail below with regard to FIG. 7.

In addition, the environment 600 may also include one or more servers 604. The one or more servers 604 may generate, store, receive, and transmit any type of data, camera data, sensor data, or other information related to machine learning development. For example, a server 604 may receive data from a client device, such as the client device 606A, and send the data to another client device, such as the client device 602B and/or 602C. The server 604 can also transmit electronic messages between one or more users of the environment 600. In one example embodiment, the server 604 is a data server. The server 604 can also comprise a communication server or a web-hosting server. Additional details regarding the server 604 will be discussed below with respect to FIG. 7.

As mentioned, in one or more embodiments, the one or more servers 604 can include or implement at least a portion of the machine learning pipeline system 100 and can comprise an application running on the one or more servers 604, or a portion of the machine learning pipeline system 100 can be downloaded from the one or more servers 604. For example, the machine learning pipeline system 100 can include a web hosting application that allows the client devices 606A-606C to interact with content hosted at the one or more servers 604. To illustrate, in one or more embodiments of the environment 600, one or more client devices 606A-606C can access a webpage supported by the one or more servers 604. In particular, the client device 606A can run a web application (e.g., a web browser) to allow a user to access, view, and/or interact with a webpage or website hosted at the one or more servers 604.

Upon the client device 606A accessing a webpage or other web application hosted at the one or more servers 604, in one or more embodiments, the one or more servers 604 can provide access to sensor data, camera data or other data associated with a machine learning development stored at the one or more servers 604. Moreover, the client device 606A can receive a request (i.e., via user input) to perform a machine learning development or inquiry and provide the request to the one or more servers 604. Upon receiving the request, the one or more servers 604 can automatically perform the methods and processes described above. The one or more servers 604 can provide all or portions of machine learning development or inquiry analysis to the client device 606A for display to the user. The one or more servers 604 can also host a machine learning pipeline application used for machine learning development purposes.

As just described, the machine learning pipeline system 100 may be implemented in whole, or in part, by the individual elements 602-608 of the computing environment 600. It will be appreciated that although certain components of machine learning pipeline system 100 are described in the previous examples with regard to particular elements of the computing environment 600, various alternative implementations are possible. For instance, in one or more embodiments, the machine learning pipeline system 100 is implemented on any of the client devices 606A-C. Similarly, in one or more embodiments, the machine learning pipeline system 100 be implemented on the one or more servers 604. Moreover, different components and functions of machine learning pipeline system 100 may be implemented separately among client devices 606A-606C, the one or more servers 604, and the network 608.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, software as a Service (“SaaS”), platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Operating Environment

Having described an overview of embodiments of the present technology, an example operating environment in which embodiments of the present technology may be implemented is described in order to provide a general context for various aspects of the present technology. Referring now to FIG. 7, in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should computing device 700 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 702 that directly or indirectly couples the following devices: memory 704, one or more processors 706, one or more presentation components 708, input/output ports 710, input/output components 712, and illustrative power supply 714. Bus 702 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 7 merely illustrates an example computing device that can be used in connection with one or more embodiments of the present technology. A distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 704 includes computer storage media in the form of volatile or nonvolatile memory. The memory may be removable, non-removable, or a combination thereof. Examples of hardware devices include solid-state memory, hard drives, optical-disc drives, etc. Computing device 700 includes one or more processors that read data from various entities, such as memory 704 or I/O components 712. Presentation component(s) 708 presents data indications to a user or other device. Examples of presentation components include a display device, speaker, printing component, vibrating component, etc.

I/O ports 710 allow computing device 700 to be logically coupled to other devices, including I/O components 720, some of which may be built in. Illustrative components include a microphone, joystick, game pad, satellite dish, scanner, printer, wireless device, sensors, etc.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method of machine learning creation and implementation, the method comprising:
generating a user interface (UI) including selection fields associated with a machine learning project onto a display;
receiving, via the UI, selections from the selection fields associated with the machine learning project and machine learning model characteristics;
initializing the machine learning project based, at least partially, on the selections;
training a machine learning model associated with the machine learning project using training data; and
integrating the machine learning model into a computing environment of a production system associated with the machine learning project.

2. The method of claim 1, wherein the selection fields include model parameters and training parameters associated with the machine learning model.

3. The method of claim 1, further comprising producing a notification over a collaboration and communication platform including details of the machine learning model.

4. The method of claim 1, wherein initializing the machine learning project includes associating training methodology of the machine learning model with the selections.

5. The method of claim 1, further comprising populating a database with metadata associated with the machine learning model.

6. The method of claim 4, further comprising:
implementing a generative pre-trained transformer (GPT) configured to respond to inquiries associated with the machine learning project and other related projects using database schema of the database;
receiving, via the UI, a text string inputted into an input field;
parsing the text string into relevant fields associated with a project;
generating a query based on the relevant fields and the database schema;
retrieving query results of the query inputted into the database;
converting the query results into a natural language explanation by inputting the query results into the GPT; and
providing the natural language explanation associated with the text string.

7. The method of claim 1, further including adding the machine learning model into a machine learning repository of machine learning models used in other related projects.

8. The method of claim 1, further comprising:
receiving, via the UI, a message including an image and a text string;
detecting contents of the message that indicate a process request of the image;
classifying the image with a label indicating a project suited for object detection of the image;
selecting the machine learning model from a machine learning repository and associated with the project;
producing predictions for detected objects in the image using the machine learning model; and
providing a processed image including the predictions of the detected objects found in the image.

9. The method of claim 8, wherein the processed image includes annotations with bounding boxes around the objects detected including labels for each of the objects.

10. The method of claim 8, further comprising:
processing the image for compatibility with the machine learning model by adjusting characteristics of the image to meet criteria associated with the machine learning model.

11. A system comprising:
one or more processors; and
one or more non-transitory computer storage media storing instructions that, when used by the one or more processors, cause the one or more processors to perform operations comprising:
generating a user interface (UI) including selection fields associated with a machine learning project onto a display;
receiving, via the UI, selections from the selection fields associated with the machine learning project and machine learning model characteristics;
initializing the machine learning project based, at least partially, on the selections;
training a machine learning model associated with the machine learning project using training data; and
integrating the machine learning model into a production system associated with the machine learning project.

12. The system of claim 11, wherein the selection fields include model parameters and training parameters associated with the machine learning model.

13. The system of claim 11, further comprising producing a notification over a collaboration and communication platform including details of the machine learning model.

14. The system of claim 11, wherein initializing the machine learning project includes associating training methodology of the machine learning model with the selections.

15. The system of claim 11, further comprising populating a database with metadata associated with the machine learning model.

16. The system of claim 15, further comprising:
implementing a generative pre-trained transformer (GPT) configured to respond to inquiries associated with the machine learning project and other related projects using database schema of the database;
receiving, via the UI, a text string inputted into an input field;
parsing the text string into relevant fields associated with a project;
generating a query based on the relevant fields and the database schema;
retrieving query results of the query inputted into the database;
converting the query results into a natural language explanation by inputting the query results into the GPT; and
providing the natural language explanation associated with the text string.

17. The system of claim 11, further including adding the machine learning model into a machine learning repository of machine learning models used in other related projects.

18. A non-transitory computer readable storage medium including instructions stored thereon which, when executed by a processor, cause the processor to:
generate a user interface (UI) including selection fields associated with a machine learning project onto a display;
receive, via the UI, selections from the selection fields associated with the machine learning project and machine learning model characteristics;
initialize the machine learning project based, at least partially, on the selections;
train a machine learning model associated with the machine learning project using training data; and
integrate the machine learning model into a production system associated with the machine learning project.

19. The non-transitory computer readable storage medium of claim 18, further cause the processor to:
receiving, via the UI, a message including an image and a text string;
detecting contents of the message indicate a process request of the image;
classifying the image with a label indicating a project suited for object detection of the image;
selecting the machine learning model from a machine learning repository and associated with the project;
producing predictions for detected objects in the image using the machine learning model; and
providing a processed image including the predictions of the detected objects found in the image.

20. The non-transitory computer readable storage medium of claim 18, further cause the processor to:
implementing a generative pre-trained transformer (GPT) configured to respond to inquiries associated with the machine learning project and other related projects using database schema of the database;
receiving, via the UI, a text string inputted into an input field;
parsing the text string into relevant fields associated with a project;
generating a query based on the relevant fields and the database schema;
retrieving query results of the query inputted into the database;
converting the query results into a natural language explanation by inputting the query results into the GPT; and
providing the natural language explanation associated with the text string.
